(19) United States
(12) Patent Application Publication
(10) Pub. No.: US 2022/0222519 A1
(43) Pub. Date: Jul. 14, 2022

(54) OPTIMIZING OPERATIONS IN ARTIFICIAL NEURAL NETWORK

(71) Applicant: Mipsology SAS, Palaiseau (FR)

(72) Inventor: Ludovic Larzul, El Dorado Hills, CA (US)

(21) Appl. No.: 17/147,607

(22) Filed: Jan. 13, 2021

(51) Int. Cl. G06N 3/08; G06N 3/04

(52) U.S. Cl. CPC G06N 3/08; G06N 3/04

(57) ABSTRACT

Systems and methods for optimizing operations in artificial neural network computations are disclosed. An example method may include selecting a first input value from a set of input values to a neuron, selecting, based on a criterion, a second input value from the set of input values, acquiring a first weight from a set of weights, acquiring a second weight from a set of weights, performing, in parallel, a first mathematical operation on the first input value and the first weight to obtain a first result, a second mathematical operation based on the second input value and the second weight to obtain a second result, the second mathematical operation requiring less number of bits than the first mathematical operation, the second number of bits being less than the first number of bits, and computing an output of the neuron based on the first result and the second result.

### TECHNICAL FIELD

The present disclosure relates generally to data processing and, more particularly, to system and method for optimizing operations in artificial neural network computations.

### BACKGROUND

Artificial Neural Networks (ANNs) are simplified and reduced models reproducing behavior of human brain. The human brain contains 10-20 billion neurons connected through synapses. Electrical and chemical messages are passed from neurons to neurons based on input information and their resistance to passing information. In the ANNs, a neuron can be represented by a node performing a simple operation of addition coupled with a saturation function. A synapse can be represented by a connection between two nodes. Each of the connections can be associated with an operation of multiplication by a constant. The ANNs are particularly useful for solving problems that cannot be easily solved by classical computer programs.

While forms of the ANNs may vary, they all have the same basic elements similar to the human brain. A typical ANN can be organized into layers, each of the layers may include many neurons sharing similar functionality. The inputs of a layer may come from a previous layer, multiple previous layers, any other layers or even the layer itself. Major architectures of ANNs include Convolutional Neural Network (CNN), Recurrent Neural Network (RNN) and Long Term Short Memory (LTSM) network, but other architectures of ANN can be developed for specific applications. While some operations have a natural sequence, for example a layer depending on previous layers, most of the operations can be carried out in parallel within the same layer. The ANNs can then be computed in parallel on many different computing elements similar to neurons of the brain. A single ANN may have hundreds of layers. Each of the layers can involve millions of connections. Thus, a single ANN may potentially require billions of simple operations like multiplications and additions.

Because of the larger number of operations and their parallel nature, ANNs can result in a very heavy load for processing units (e.g., CPU), even ones running at high rates. Sometimes, to overcome limitations of CPUs, graphics processing units (GPUs) can be used to process large ANNs because GPUs have a much higher throughput capacity of operations in comparison to CPUs. Because this approach solves, at least partially, the throughput limitation problem, GPUs appear to be more efficient in the computations of ANNs than the CPUs. However, GPUs are not well suited to the computations of ANNs because the GPUs have been specifically designed to compute graphical images.

The GPUs may provide a certain level of parallelism in computations. However, the GPUs are constraining the computations in long pipes implying latency and lack of reactivity. To deliver the maximum throughput, very large GPUs can be used which may involving excessive power consumption, a typical issue of GPUs. Since the GPUs may require more power consumptions for the computations of ANNs, the deployment of GPUs can be difficult.

To summarize, CPUs provide a very generic engine that can execute very few sequences of instructions with a minimum effort in terms of programming, but lack the power of computing for ANN. GPUs are slightly more parallel and require a larger effort of programming than CPUs, which can be hidden behind libraries with some performance costs, but are not very well suitable for ANNs.

Field Programmable Gate Arrays (FPGAs) are professional components that can be programmed at the hardware level after they are manufactured. The FPGAs can be configured to perform computations in parallel. Therefore, FPGAs can be well suited to compute ANNs. One of the challenges of FPGAs is the programming, which requires a much larger effort than programming CPUs and GPUs. Adaption of FPGAs to perform ANN computations can be more challenging than for CPUs and GPUs.

Most attempts in programming FPGAs to compute ANNs have being focusing on a specific ANN or a subset of ANNs, or requiring modifying the ANN structure to fit into a specific limited accelerator, or providing a basic functionality without solving the problem of computing ANN on FPGAs globally. The computation scale is typically not considered for existing FPGA solutions, many of the research being limited to a single or few computation engines, which could be replicated. The existing FPGA solutions do not solve the problem of massive data movement required at large scale for the actual ANN involved in real industrial applications. The inputs to be computed with an ANN are typically provided by an artificial intelligence (AI) framework. Those programs are used by the AI community to develop new ANN or global solutions based on ANN. FPGAs are also lacking integration in those software environments.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

According to one example embodiments, a system for optimizing operations in ANN computations is provided. The system may include a processing unit. The processing unit can be configured to select a first input value from a set of input values to a neuron. The processing unit can be configured to select, based on a criterion, a second input value from the set of input values to the neuron. The processing unit can be configured to acquire a first weight from a set of weights corresponding to the first input value. The processing unit can be configured to acquire a second weight from a set of weights corresponding to the second input value. The processing unit can be configured to perform, in parallel, a first mathematical operation on the first input value and the first weight to obtain a first result and a second mathematical operation based on a set of the bits of the second input value and the second weight to obtain a second result. The first mathematical operation can require a first number of bits. The second mathematical operation can require a second number of bits. The second number of bits can be smaller than the first number of bits. The processing unit can be configured to compute an output of the neuron based on the first result and the second result.

The first mathematical operation includes a multiplication product. The second mathematical operation includes a bitwise shift of the second weight. Instead of performing the second mathematical operation, the processing unit can be configured to provide, without modifying, the second weight to an accumulating unit. The accumulating unit can be configured to add the second weight to a sum. The sum can be used to compute the output of the neuron. The accumulating unit may include an enable for configuring the accumulating unit to add the second weight to the sum.

The first input value and the second input value include the same number of bits in the set of input values. The processing unit can be configured to perform operations on a part of bits of the second input value. A number of bits in the part of bits can be less than a number of bits in the second input value. The selection of the second input value includes comparing the second input value to at least one reference value. Instead of comparing the value to at least one reference value, the selection of the second input value may include comparing a subset of the bits of the second value to 0 or 1.

The processing unit can be configured to provide the first input value or the second input value to at least one further processing unit in parallel to performing the first mathematical operation and the second mathematical operation. The processing unit can be integrated into an electronic circuit configured to perform computations of the ANN. The electronic circuit can include a first circuitry to perform the first operation and a second circuitry to perform the second operation, where a number of transistors in the second circuitry is less than a number of the transistors in the first circuitry.

According to another example embodiment, a method for optimizing operations in ANN computations is provided. The method can be performed by at least one processing unit. The method may include selecting a first input value from a set of input values to a neuron. The method may include selecting, based on a criterion, a second input value from the set of input values to the neuron. The method may also include acquiring a first weight from a set of weights corresponding to the first input value. The method may also include acquiring a second weight from a set of weights corresponding to the second input value. The method may also include performing, in parallel, a first mathematical operation on the first input value and the first weight to obtain a first result and a second mathematical operation based on a set of the bits of the second input value and the second weight to obtain a second result. The first mathematical operation can require a first number of bits. The second mathematical operation can require a second number of bits. The second number of bits can be less than the first number of bits. The method may include computing an output of the neuron based on the first result and the second result.

Additional objects, advantages, and novel features will be set forth in part in the detailed description section of this disclosure, which follows, and in part will become apparent to those skilled in the art upon examination of this specification and the accompanying drawings or may be learned by production or operation of the example embodiments. The objects and advantages of the concepts may be realized and attained by means of the methodologies, instrumentalities, and combinations particularly pointed out in the appended claims.

### BRIEF DESCRIPTION OF THE DRAWINGS

Embodiments are illustrated by way of example and not limitation in the figures of the accompanying drawings, in which like references indicate similar elements and, in which:

FIG. 1 is a block diagram showing an example system wherein a method for optimizing operations in ANN computations can be implemented, according to some example embodiments.

FIG. 2 shows an ANN, neuron, and transfer function, according to an example embodiment.

FIG. 3 is a flow chart showing training and inference of ANN, according to some example embodiments.

FIG. 4 is a block diagram showing a processing unit for optimizing operations in ANN computations, according to some example embodiments.

FIG. 5 is a block diagram showing an accumulating unit for optimizing operations in ANN computations, according to an example embodiment.

FIG. 6 is a schematic 600 showing a timeline for calculating a neuron by using standard multiplications and time for calculating the neuron using a set of operations, according some example embodiments.

FIG. 7 is a flow chart showing steps of a method for optimizing operations in ANN computations, according to some example embodiments.

FIG. 8 shows a computing system that can be used to implement embodiments of the disclosed technology.

### DETAILED DESCRIPTION

The following detailed description includes references to the accompanying drawings, which form a part of the detailed description. The drawings show illustrations in accordance with exemplary embodiments. These exemplary embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents.

For purposes of this document, the terms “or” and “and” shall mean “and/or” unless stated otherwise or clearly intended otherwise by the context of their use. The term “a” shall mean “one or more” unless stated otherwise or where the use of “one or more” is clearly inappropriate. The terms “comprise,” “comprising,” “include,” and “including” are interchangeable and not intended to be limiting. For example, the term “including” shall be interpreted to mean “including, but not limited to.”

Embodiments of this disclosure are concerned with methods and systems for optimizing operations in ANN computations. Embodiments of the present disclosure may monitor number of meaningful bits of input values to neurons of an ANN and weights of the input values to neurons and select, based on the meaningful bits, a type of mathematical operations needed to obtain products of the input values and the weights. Embodiments of the present disclosure may also allow to perform, in parallel, at least two operations for obtaining a first product of a first input value and a first weight and a logic operation equivalent to a second product of a second input value and a second weight, where the first product and the logic operation equivalent to the second product are determined by different mathematical operations. Number of bits required for obtaining the second product can be less then number of bits required for obtaining the first product. Correspondently, the size and number of elements of an electrical circuit designed for obtaining the second product result can be less than the size and number of elements of an electrical circuit designed for obtaining the first product result. Thus, embodiments of the present disclosure may allow to avoid performing complex mathematical operations in ANN computations or to reduce the overall complexity of some mathematical operations in the ANN computations, and, thereby, reduce the size of hardware for computing ANNs.

While some embodiments of the present disclosure are described herein with reference to operations of FPGAs, the present technology may be also practiced with application-specific integrated circuits (ASICs), programmable logic devices, transistor-based electronic circuits, CPUs, or various combinations thereof. The methods described herein can be also implemented by hardware modules, software modules, or combinations of both. The methods can also be embodied in computer-readable instructions stored on computer-readable media.

The term “module” shall be construed to mean a hardware device, software, or a combination of both. For example, a hardware-based module can use one or more microprocessors, FPGAs, application-specific integrated circuits (ASICs), programmable logic devices, transistor-based circuits, CPUs, or various combinations thereof. Software-based modules can constitute computer programs, computer program procedures, computer program functions, and the like. In addition, a module of a system can be implemented by a computer or server, or by multiple computers or servers interconnected into a network. Alternatively, module may also refer to a subpart of a computer system, a hardware device, an integrated circuit, or a computer program.

Technical effects of certain embodiments of the present disclosure can include configuring or designing integrated circuits, FPGAs, or computer systems to perform ANN computations without execution of redundant and unnecessary mathematical operations, or by dynamically reducing the complexity of some mathematical operations, thereby accelerating the ANN computations or using fewer transistors in electronic circuits to obtain the same result. Further technical effects of some embodiments of the present disclosure can facilitate configuration or design of integrated circuits, FPGAs, or computer systems to dynamically qualify data on which mathematical operations are to be performed in the ANN computations. Yet further technical effects of embodiments of the present disclosure include configuration or design of integrated circuits, FPGAs, or computer systems to dynamically align results of neuron computations performed in parallel by multiple processing units.

Referring now to the drawings, exemplary embodiments are described. The drawings are schematic illustrations of idealized example embodiments. Thus, the example embodiments discussed herein should not be construed as limited to the particular illustrations presented herein, rather these example embodiments can include deviations and differ from the illustrations presented herein.

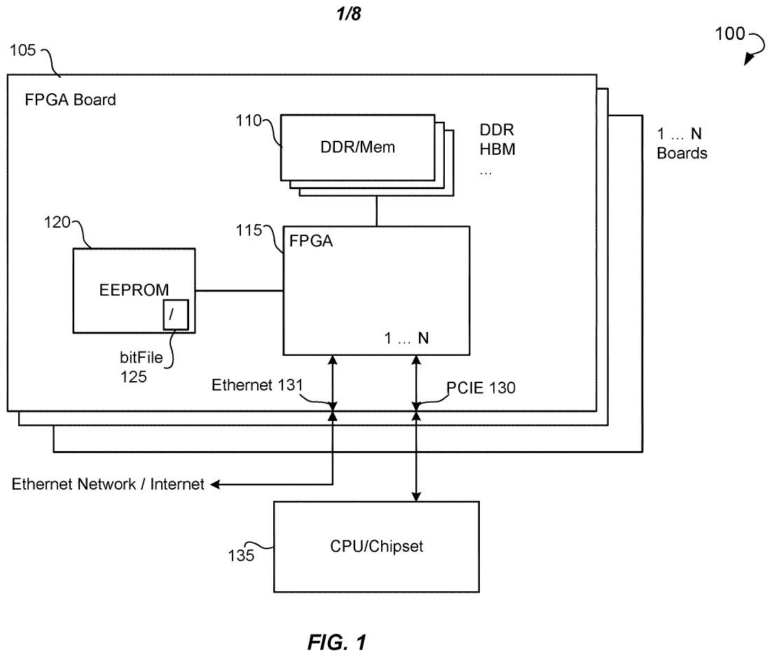

FIG. 1 is a block diagram showing an example system 100, where a method for optimizing operations in ANN computations can be implemented, according to some example embodiments. The system 100 can be part of a computing system, such as a personal computer, a server, a cloud-based computing recourse, and the like. The system 100 may include one or more FPGA boards 105 and a chipset 135 including a least one CPU. The chipset 135 can be communicatively connected to the FPGA boards 105 via a communication interface. The communication interface may include a Peripheral Component Interconnect Express (PCIE) standard 130. The communication interface may also include an Ethernet connection 131.

The FPGA board 105 may include an FPGA 115, a volatile memory 110, and a non-volatile memory 120. The volatile memory 110 may include a double data rate synchronous dynamic random-access memory (DDR SDRAM), High Bandwidth Memory (HBM), or any other type of memory. The volatile memory 110 may include the host memory. The non-volatile memory 120 may include Electrically Erasable Programmable Read-Only Memory (EEROM), a solid-state drive (SSD), a flash memory, and so forth.

The FPGA 115 can include blocks. The blocks may include a set of elementary nodes (also referred to as gates) performing basic hardware operations, such as Boolean operations. The blocks may further include registers retaining bit information, one or more memory storages of different sizes, and one or more digital signal processors (DSPs) to perform arithmetic computations, for example, additions and multiplications. Programming of FPGA 115 may include configuring each of the blocks to have an expected behavior and connecting the blocks by routing information between the blocks. Programming of FPGA 115 can be carried out using a result from a compiler receiving as input schematic description, gate-level description, hardware languages like Verilog, System Verilog, or Very High Speed Integrated Circuit Hardware Description Language (VHDL), or any combination of thereof.

The non-volatile memory 120 may be configured to store instructions in a form of bit file 125 to be executed by the FPGA 115. The FPGA 115 can be configured by the instructions to perform one or more floating point operations including multiplication and addition to calculate the sum of products that can be used in neural network computations.

The volatile memory 110 can be configured to store weights W[i] for neurons of one or more ANNs, input values V[i] to be processed for the ANNs, and results of ANNs computation including any intermediate results of computations of layers of the ANNs.

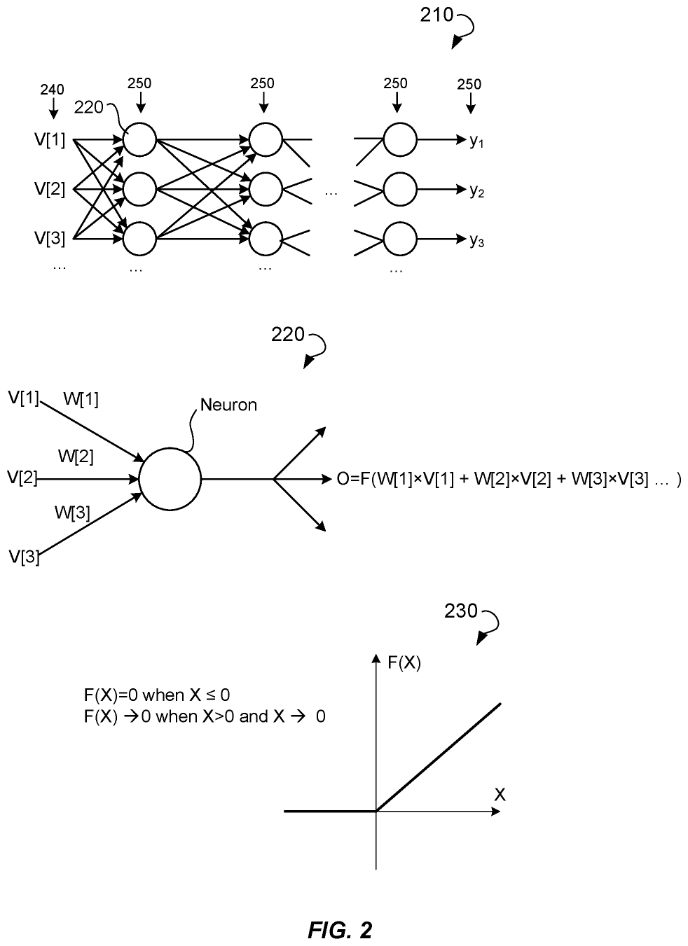

FIG. 2 shows ANN 210, neuron 220, and transfer function 230, according to some example embodiments. The ANN 210 may include one or more input layers 240, one or more hidden layers 250, and one or more output layers 260. Each of the input layers, hidden layers, and output layers may include one or more (artificial) neurons 220. The number of neurons can be different for different layers.

Each of neurons 220 may represent a calculation of a mathematical function

$$O = F ( {\sum }_{i = 1}^{n} V [ i ] \times W [ i ] ) \qquad ( 1 )$$

wherein V[i] are neuron input values, W[i] are weights assigned to input values at neuron, and F(X) is a transfer function. Typically, the transfer function 230 F(X) is selected to be zero for X<0 and have a limit of zero as X approaches zero. For example, the transfer function F(X) can be in the form of a sigmoid. The result of calculation of a neuron propagates as an input value of further neurons in the ANN. The further neurons can belong to either the next layer, a previous layer or the same layer.

It should be noted that while the ANN 210 illustrated in FIG. 2 can be referred to as a feedforward neural network, embodiments of the present disclosure can be also used in computations of convolution neural networks, recurrent neural networks, long short-term memory networks, and other types of ANNs.

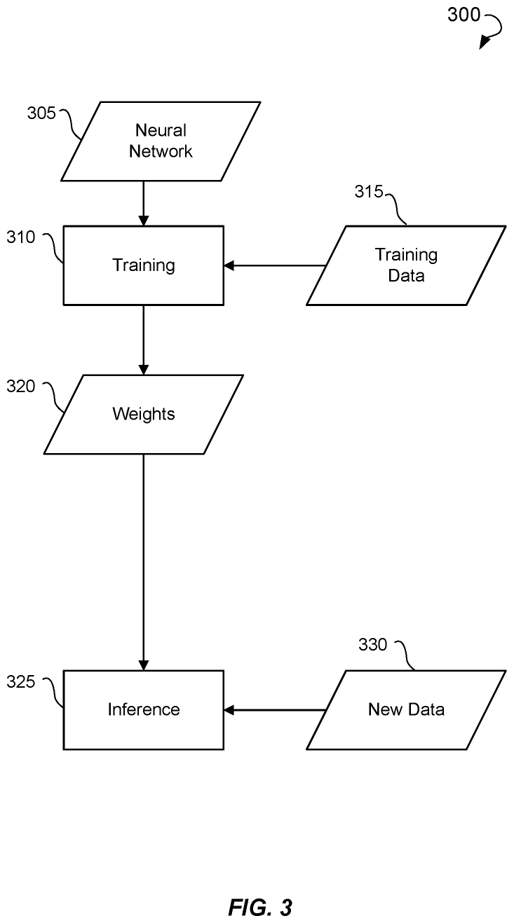

FIG. 3 is a flow chart showing training 310 and inference 325 of an ANN, according to some example embodiments. The training 310 (also known as learning) is a process of teaching ANN 305 to output a proper result based on a given set of training data 315. The process of training may include determining weights 320 of neurons of the ANN 305 based on training data 315. The training data 315 may include samples. Each of the samples may be represented as a pair of input values and an expected output. The training data 315 may include hundreds to millions of samples. While the training 310 is required to be performed only once, it may require a significant number of computations and considerable time. The ANNs can be configured to solve different tasks including, for example, image recognition, speech recognition, handwriting recognition, machine translation, social network filtering, video games, medical diagnosis, and so forth.

The inference 325 is a process of computation of an ANN. The inference 325 uses the trained ANN weights 320 and new data 330 including new sets of input values. For each new set of input values, the computation of the ANN provides a new output which answers the problem that the ANN is supposed to solve. For example, an ANN can be trained to recognize various animals in images. Correspondingly, the ANN can be trained on millions of images of animals. Submitting a new image to the ANN would provide the information for animals in the new image (this process being known as image tagging). While the inference for each image takes less computations than training, number of inferences can be large because new images can be received from billions of sources.

The inference 325 includes multiple computations of sum of products:

$${\sum }_{i = 1}^{n} V [ i ] \times W [ i ] \qquad ( 2 )$$

wherein the V[i] are new input values and W[i] are weights associated with neurons of ANN.

During the inference 325, the weights W[i] (weights 320) may remain unchanged while input values V[i] are dynamic and depend on input data to the ANN. The inference 325 may include multiplication by zero that can be avoided by inspecting input values V[i] and weights W[i]. Multiplications V[i]×W[i] can be not carried out if a predetermined criterion is satisfied with respect to input value V[i] and weight W[i]. For example, multiplication V[i]×W[i] can be skipped if the input value V[i] or weight W[i] is substantially zero. If the predetermined criterion for skipping the multiplications is not satisfied, then the multiplications V[i]×W[i] are performed. Currently the same accumulating unit is used for performing any of the multiplications V[i]×W[i] without considering values of the input values V[i] or weights W[i].

In some embodiments of the present disclosure, the values of the input values V[i] or weights W[i] can be inspected to determine amount of bit operations required to perform the multiplication V[i]×W[i]. Depending on values of the input values V[i] or weights W[i], some embodiments of the present disclosure may allow performing, in parallel, at least two mathematical operations on at least two pairs (V[i], W[i]) and (V[i₂], W[i₂]), wherein obtaining a value of the product V[i₂]×W[i₂] requires less bitwise operations (and, hence, a circuitry of a smaller size) than obtaining a value of the product V[i]×W[i]. This approach allows dynamically reducing the complexity of mathematical operations based on the input values V[i] and other values, for example, static values including weights. Thus, in contrast to previous approaches, embodiments of the present disclosure may allow dynamic selection of operations to be performed on an optimal computing logic.

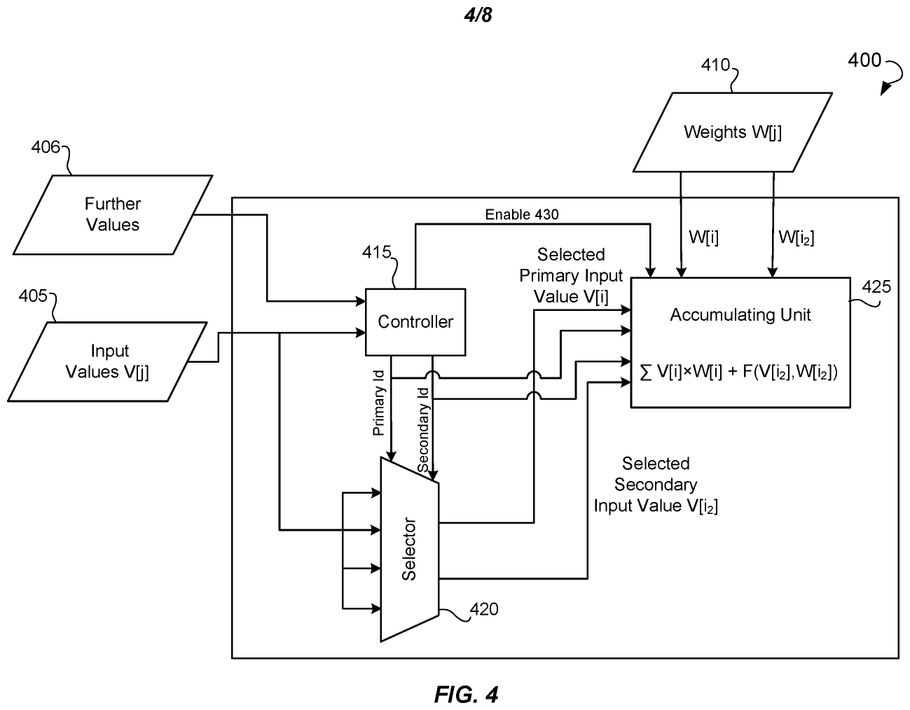

FIG. 4 is a block diagram showing a processing unit 400 for accelerating ANN computation, according to some example embodiments. The processing unit 400 may include a controller 415, a selector 420, and an accumulating unit 425.

The controller 415 may receive a set {V[j₀], V[j₁], . . . , V[jₓ₋₁]} of X input values 405 to a neuron. The controller 415 may optionally receive further input values 406 which are different from the input values 405. The further input values 406 can be related to the neuron, the layer, the ANN, the weights, the operation to be carried or any other kind of values. The controller 415 may provide, based on the input values 405 and the further values 406, an indication to the selector 420 as to which X input values to select from the set of input values 405.

The controller 415 may provide, to the selector 420, a primary identifier of a primary input value V[i] and a secondary identifier of a secondary input value V[i₂]. The controller 415 may also provide the primary identifier and the secondary identifier to the accumulating unit 425. Both the primary identifier and the secondary identifier may include an offset, an index, or bit enables of the selected input values in the set {V[j₀], V[j₁], . . . , V[jₓ₋₁]}. The controller 415 may also provide an enable 430 to the accumulating unit 425.

The controller 415 can be configured to select the secondary input value V[i₂] based on criteria −K≤V[i₂]<L. In various embodiments, interval [−K;L] can be one of the following: [0;1], [−2;1], [−4:3], and so forth, allowing to perform mathematical operations equivalent to standard multiplication of V[i₂] and corresponding weights, such that the mathematical operations require using less bits than the standard multiplication. The controller 415 may include a comparator for comparing V[i₂] to −K and L. The primary input value V[i] can be used to calculate products of V[i] and corresponding weights using standard multiplication operation. The controller 415 can be configured to avoid selecting secondary input value V[i₂] as the primary input value as a parameter of the standard multiplication operation because V[i₂] is already used in an operation simpler than the standard multiplication. This allows substantially doubling the speed of computing of a given set of multiplications to determine the output of a neuron in an ANN.

The selector 420 may receive the set of input values {V[i₀], V[i₁], . . . V[iₓ₋₁]} and the primary identifier and the secondary identifier from the controller 415. The selector 420 may select, based on the primary identifier, a primary input value V[i] and provide the selected primary input value V[i] to the arithmetic unit 425. The selector 420 may select, based on the secondary identifier, a secondary input value V[i₂], and provide the selected secondary input value V[i₂] to the arithmetic unit 425. The arithmetic unit 425 can select, based on the primary identifier, weight W[i] corresponding to the primary input value V[i]. The arithmetic unit 425 can select, based on the secondary identifier, weight W[i₂] corresponding to the secondary input value V[i₂]. The arithmetic unit 425 can perform a first operation on the primary input value V[i] and corresponding weight W[i] and a second operation on the secondary input value V[i₂] and corresponding weight W[i₂]. The arithmetic unit 425 can further accumulate the results of the first operation and the second operation. Performing the second operation can require fewer bits and a simpler logic than performing the first operation. The first operation may include a standard multiplication operation.

In some embodiments, the controller 415 and the selector 420 may be carried out as a single unit configured to perform functionalities of both controller 415 and selector 420. In further embodiments, the same controller 415 can be shared between multiple processing units similar to the processing unit 400 because input values {V[i₀], V[i₁], . . . V[iₓ₋₁]} can be used multiple times with different sets of weights. In further embodiments, the processing unit 400 may include different accumulating units (similar to the accumulating unit 425) for the first operation and the second operation. In further embodiments, the selection of weights and the accumulation of results of first operation and the second operation can be carried out by different processing units.

In some embodiments, the accumulating unit 425 may be configured to perform either only the first operation or multiple second operations. In these embodiments, the accumulating unit 415 may execute one of the following: 1) single first operation on single input value and single weight; or 2) multiple second operations on multiple input values and multiple weights based on the selection by selector 420. In these embodiments, the selector 420 can be configured to select multiple secondary input values matching the criterion −K≤V[i₂]<L.

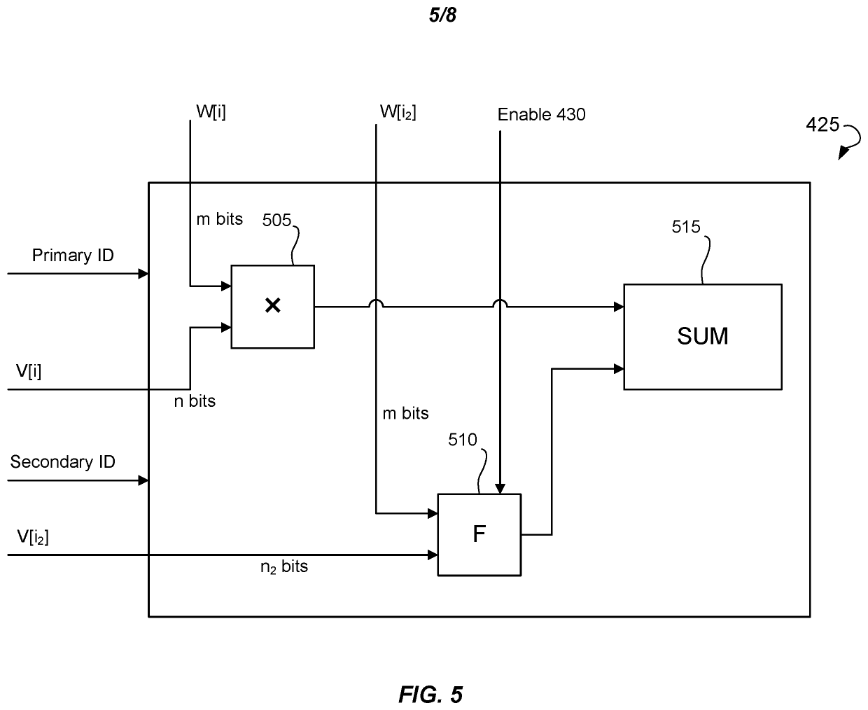

FIG. 5 is a block diagram showing the accumulating unit 425, according to some example embodiments. The accumulating unit 425 can be configured to compute sums, multiplications, accumulations, or other operations. The accumulating unit 425 may include multiplication unit 505, function unit 510, and summation unit 515. The accumulating unit 425 may include other operational units necessary for operations of the arithmetic unit 425.

The accumulating unit 425 may receive, from the controller 415, primary identifier of the primary input value V[i] and secondary identifier of the secondary input value V[i₂]. The accumulating unit 425 may receive, from the selector 420, the primary input value V[i] and the secondary input value V[i₂]. The accumulating unit 425 may be configured to select, based on the primary identifier, a weight W[i] corresponding to the primary input value V[i]. The accumulating unit 425 may be configured to select, based on the secondary identifier, weight W[i₂] corresponding to the secondary input value V[i].

The multiplication unit 505 may determine product V[i]×W[i]. The multiplication unit 505 performs m bits by n bits multiplication, where m is number of bits used for the primary input value V[i] and m is number of bits used for weight W[i].

Simultaneously with the multiplication unit 505, the function unit 510 may perform an operation on the secondary input value V[i₂] and corresponding weight W[i₂]. The function unit 510 can be designed to perform different operations based on the number of significant bits n₂ of secondary input value V[i₂]:

1) If 0≤V[i₂]≤1, then the number of bits n₂ in V[i₂] is one and the function unit 510 can perform bitwise AND operations on the secondary input value V[i₂] and corresponding weight W[i₂]. In certain embodiments, the controller 430 may provide an enable 430 to configure the function unit 510 to provide the weight W[i₂] to the accumulating unit without performing any operations. The controller 430 may provide an enable 430 enabling the accumulation of the value V[i₂] when W[i₂]=1.

2) If −2≤V[i₂]<1, but V[i₂]≠0, then n₂=2 and function unit 510 can use a simple combinatorial logic for performing m bits by n₂ multiplication.

3) If −4≤V[i₂]<3, but V[i₂]≠0, −2, −1, 0, or 1, then n₂=3.

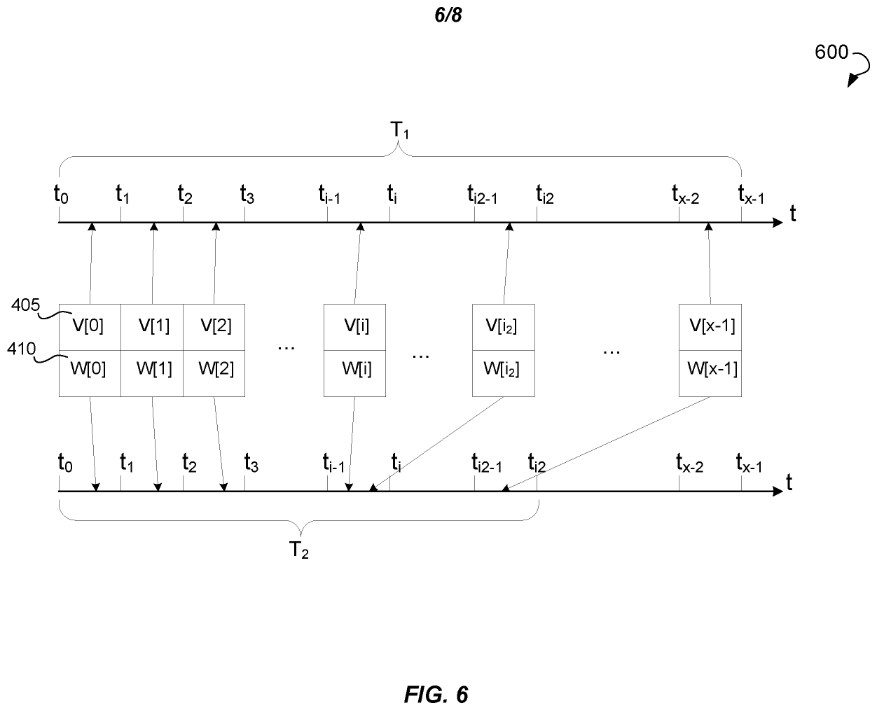

In these embodiments, function unit 510 can be designed to perform m bits by n₂ bits multiplication, which requires fewer gates and transistors than the m bit by n bit multiplication performed by the multiplication unit 505 because n₂<n. The summation unit 515 can be configured to accumulate results of parallel computations of the multiplication unit 505 and function unit 510 to a sum. FIG. 6 is a schematic 600 showing time T₁ of calculating a neuron using standard multiplication and time T₂ of calculating the neuron using a set of different operations, according to some example embodiments. The neuron can be calculated based on a set of input values {V[0], V[0], . . . , V[x−1]} and a set of weights {W[0], W[1], V[x−1]}. The time T₂ for computing an output of the neuron using a set of different operations on the input values {V[0], V[0], . . . , V[x−1]} and the corresponding weights {W[0], W[1], . . . , V[x−1]} is shorter than time T₁ for computing the output of the neuron by using only standard multiplications of size N×M on the input values {V[0], V[0], . . . , V[x−1]} and the corresponding weights {W[0], W[1], . . . , V[x−1]}.

When the criteria −K≤V[i₂]<L is matched by an input value V[i₂], the multiplication V[i₂]×W[i₂] is not executed by the multiplication unit 505 (shown in FIG. 5) during period [tᵢ_{₂}₋₁; tᵢ_{₂}] but performed by the function unit 510 during time period [tᵢ₋₁; tᵢ] in parallel with multiplication V[i]×W[i]. Thus, multiplication unit 505 can use the free period [tᵢ_{₂}₋₁; tᵢ_{₂}] to perform other multiplications of the same neuron. Accordingly, the summation unit 515 can obtain the sum earlier with less logic than when using only standard N×M bit multiplications.

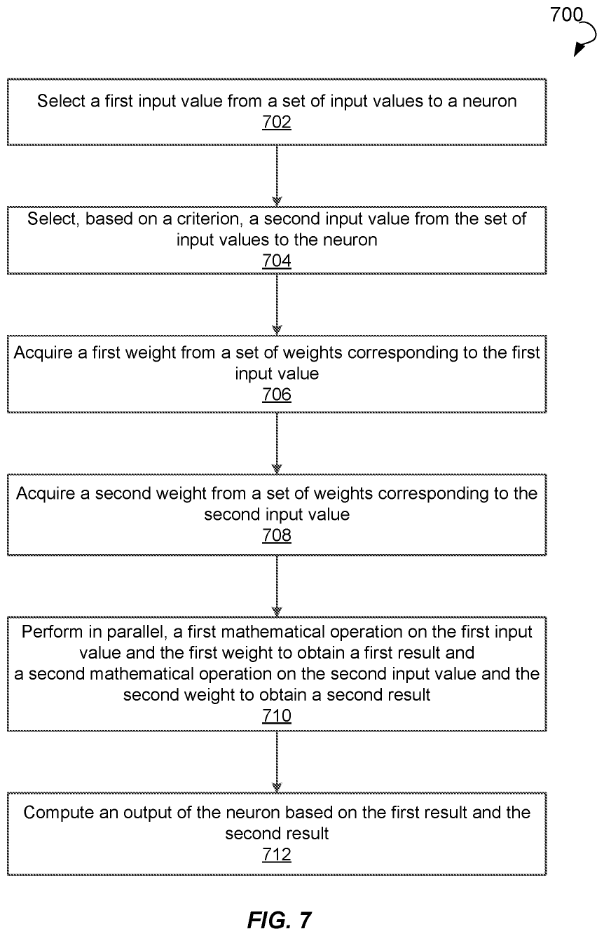

FIG. 7 is a flow chart illustrating a method 700 for optimizing operations in ANN computations, in accordance with some example embodiments. In some embodiments, the operations may be combined, performed in parallel, or performed in a different order. The method 700 may also include additional or fewer operations than those illustrated. The method 700 may be performed by processing unit 400 described above with reference to in FIG. 4 and FIG. 5.

In block 702, the method 700 commence with selecting a first input value from a set of input values to a neuron. In block 704, the method 700 may select, based on a criterion, a second input value from the set of input values to the neuron. Selecting the second input value may include comparing the second input value to at least one reference value. The first input value and the second input value may include the same number of bits in the set of input values. In block 706, the method 700 may acquire a first weight from a set of weights corresponding to the first input value. In block 708, the method 700 may acquire a second weight from a set of weights corresponding to the second input value.

In block 710, the method 700 may perform, in parallel, a first mathematical operation on the first input value and the first weight to obtain a first result and a second mathematical operation on the second input value and the second weight to obtain a second result. The first mathematical operation can require a first number of bits. The second mathematical operation can require a second number of bits, the second number of bits being less than the first number of bits. The first mathematical operation may include a multiplication product. The second mathematical operation may include a bitwise shift of the second weight.

The second mathematical operation can be performed based on a part of bits of the second input value. The part of bits can include a number of bits smaller than a number of bits in the second input value. Instead of performing the second mathematical operation, the method may include providing, without modifying, the second weight to an accumulating unit, the accumulating unit being configured to add the second weight to a sum being used to compute the output of the neuron (equation (2)). The accumulating unit includes an enable for configuring the accumulating unit to add the second weight to the sum.

In block 712, the method 700 may include computing an output of the neuron based on the first result and the second result. The method 700 may include providing the first input value or the second input value to at least one further processing unit in parallel to performing the first mathematical operation and the second mathematical operation. The processing unit can be integrated into an electronic circuit configured to perform computations of the ANN.

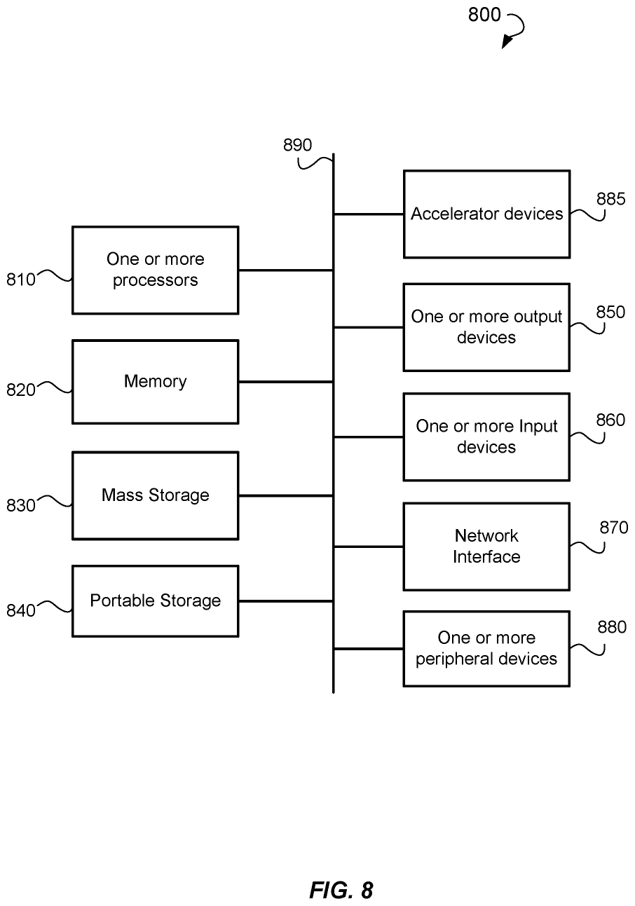

FIG. 8 illustrates an example computing system 800 that may be used to implement embodiments described herein. The example computing system 800 of FIG. 8 may include one or more processors 810 and memory 820. Memory 820 may store, in part, instructions and data for execution by the one or more processors 810. Memory 820 can store the executable code when the exemplary computing system 800 is in operation. The processor 810 may include internal accelerators like a graphical processing unit, a Field Programmable Gate Array, or similar accelerators that may be suitable for use with embodiments described herein. The memory 820 may include internal accelerators like a graphical processing unit, a Field Programmable Gate Array, or similar accelerators that may be suitable for use with embodiments described herein. The example computing system 800 of FIG. 8 may further include a mass storage 830, portable storage 840, one or more output devices 850, one or more input devices 860, a network interface 870, and one or more peripheral devices 880.

The components shown in FIG. 8 are depicted as being connected via a single bus 890. The components may be connected through one or more data transport means. The one or more processors 810 and memory 820 may be connected via a local microprocessor bus, and the mass storage 830, one or more peripheral devices 880, portable storage 840, and network interface 870 may be connected via one or more input/output buses.

Mass storage 830, which may be implemented with a magnetic disk drive, an optical disk drive or a solid state drive, is a non-volatile storage device for storing data and instructions for use by a magnetic disk, an optical disk drive or SSD, which in turn may be used by one or more processors 810. Mass storage 830 can store the system software for implementing embodiments described herein for purposes of loading that software into memory 820. The mass storage 830 may also include internal accelerators like a graphical processing unit, a Field Programmable Gate Array, or similar accelerators that may be suitable for use with embodiments described herein.

Portable storage 840 may operate in conjunction with a portable non-volatile storage medium, such as a compact disk (CD) or digital video disc (DVD), to input and output data and code to and from the computing system 800 of FIG. 8. The system software for implementing embodiments described herein may be stored on such a portable medium and input to the computing system 800 via the portable storage 840.

One or more input devices 860 provide a portion of a user interface. The one or more input devices 860 may include an alphanumeric keypad, such as a keyboard, for inputting alphanumeric and other information, or a pointing device, such as a mouse, a trackball, a stylus, or cursor direction keys. Additionally, the computing system 800 as shown in FIG. 8 includes one or more output devices 850. Suitable one or more output devices 850 include speakers, printers, network interfaces, and monitors.

Network interface 870 can be utilized to communicate with external devices, external computing devices, servers, and networked systems via one or more communications networks such as one or more wired, wireless, or optical networks including, for example, the Internet, intranet, LAN, WAN, cellular phone networks (e.g., Global System for Mobile communications network, packet switching communications network, circuit switching communications network), Bluetooth radio, and an IEEE 802.11-based radio frequency network, among others. Network interface 770 may be a network interface card, such as an Ethernet card, optical transceiver, radio frequency transceiver, or any other type of device that can send and receive information. Other examples of such network interfaces may include Bluetooth®, 3G, 4G, and WiFi® radios in mobile computing devices as well as a USB.

One or more peripheral devices 880 may include any type of computer support device to add additional functionality to the computing system. The one or more peripheral devices 880 may include a modem or a router.

The example computing system 800 of FIG. 8 may also include one or more accelerator devices 885. The accelerator devices 885 may include PCIe-form-factor boards or storage-form-factor boards, or any electronic board equipped with a specific electronic component like a Graphical Processing Unit, a Neural Processing Unit, a Multi-CPU component, a Field Programmable Gate Array component, or similar accelerators electronic or photonic components, that may be suitable for use with embodiments described herein.

The components contained in the exemplary computing system 800 of FIG. 8 are those typically found in computing systems that may be suitable for use with embodiments described herein and are intended to represent a broad category of such computer components that are well known in the art. Thus, the exemplary computing system 800 of FIG. 8 can be a personal computer, handheld computing device, telephone, mobile computing device, workstation, server, minicomputer, mainframe computer, or any other computing device. The computer can also include different bus configurations, networked platforms, multi-processor platforms, and so forth. Various operating systems (OS) can be used including UNIX, Linux, Windows, Macintosh OS, Palm OS, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the example embodiments. Those skilled in the art are familiar with instructions, processor(s), and storage media.

It is noteworthy that any hardware platform suitable for performing the processing described herein is suitable for use with the example embodiments. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as RAM. Transmission media include coaxial cables, copper wire, and fiber optics, among others, including the wires that include one embodiment of a bus. Transmission media can also take the form of acoustic or light waves, such as those generated during radio frequency and infrared data communications. Common forms of computer-readable media include, for example, a floppy disk, a flexible disk, a hard disk, magnetic tape, any other magnetic medium, SSD, a CD-read-only memory (ROM) disk, DVD, any other optical medium, any other physical medium with patterns of marks or holes, a RAM, a PROM, an EPROM, an EEPROM, a FLASHEPROM, any other memory chip or cartridge, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU. The instructions or data may not be used by the CPU but be accessed in writing or reading from the other devices without having the CPU directing them.

Thus, systems and methods for optimizing operations in artificial neural ANN computations are described. Although embodiments have been described with reference to specific exemplary embodiments, it will be evident that various modifications and changes can be made to these exemplary embodiments without departing from the broader spirit and scope of the present application. Accordingly, the specification and drawings are to be regarded in an illustrative rather than a restrictive sense.

What is claimed is:

1. A system for optimizing operations in artificial neural network (ANN) computations, the system comprising a processing unit configured to:
select a first input value from a set of input values to a neuron;
select, based on a criterion, a second input value from the set of input values to the neuron;
acquire a first weight from a set of weights corresponding to the first input value;
acquire a second weight from a set of weights corresponding to the second input value;
perform in parallel:
a first mathematical operation on the first input value and the first weight to obtain a first result, the first mathematical operation requiring a first number of bits; and
a second mathematical operation based on the second input value and the second weight to obtain a second result, the second mathematical operation requiring a second number of bits, the second number of bits being less than the first number of bits; and
compute an output of the neuron based on the first result and the second result.

2. The system of claim 1, wherein the first mathematical operation includes a multiplication product.

3. The system of claim 1, wherein the second mathematical operation includes a bitwise shift of the second weight.

4. The system of claim 1, wherein instead of performing the second mathematical operation, the processing unit is configured to provide, without modifying, the second weight to an accumulating unit, the accumulating unit being configured to add the second weight to a sum, the sum being used to compute the output of the neuron.

5. The system of claim 4, wherein the accumulating unit includes an enable for configuring the accumulating unit to add the second weight to the sum.

6. The system of claim 1, wherein:
the first input value and the second input value include a same number of bits in the set of input values; and
the processing unit is configured to perform operations on a part of bits of the second input value, a number of bits in the part of bits being less than a number of bits in the second input value.

7. The system of claim 1, wherein selecting, based on the criterion, the second input value includes comparing the second input value to at least one reference value.

8. The system of claim 1, wherein the processing unit is configured to provide the first input value or the second input value to at least one further processing unit in parallel to performing the first mathematical operation and the second mathematical operation.

9. The system of claim 1, wherein the processing unit is integrated into an electronic circuit configured to perform computations of the ANN.

10. The system of claim 9, wherein the electronic circuit includes a first circuitry to perform the first operation and a second circuitry to perform the second operation and a number of transistors in the second circuitry is less than a number of the transistors in the first circuitry.

11. The system of claim 1, wherein a time to compute the output of the neuron in the ANN is less than a time to compute all multiplications between input values of the set of input values and the corresponding weights of the set of the set of weights.

12. A method for optimizing operations in artificial neural network (ANN) computations, the method being performed by at least one processing unit, the method comprising:
selecting a first input value from a set of input values to a neuron;
selecting, based on a criterion, a second input value from the set of input values to the neuron;
acquiring a first weight from a set of weights corresponding to the first input value;
acquiring a second weight from a set of weights corresponding to the second input value;
performing in parallel:
a first mathematical operation on the first input value and the first weight to obtain a first result, the first mathematical operation requiring a first number of bits; and
a second mathematical operation based on the second input value and the second weight to obtain a second result, the second mathematical operation requiring a second number of bits, the second number of bits being less than the first number of bits; and
computing an output of the neuron based on the first result and the second result.

13. The method of claim 12, wherein the first mathematical operation includes a multiplication product.

14. The method of claim 12, wherein the second mathematical operation includes a bitwise shift of the second weight.

15. The method of claim 12, further comprising instead of performing the second mathematical operation, providing, without modifying, the second weight to an accumulating unit, the accumulating unit being configured to add the second weight to a sum, the sum being used to compute the output of the neuron.

16. The method of claim 15, wherein the accumulating unit includes an enable for configuring the accumulating unit to add the second weight to the sum.

17. The method of claim 12, wherein:
the first input value and the second input value include a same number of bits in the set of input values; and
the second mathematical operation is performed on a part of bits of the second input value, a number of bits in the part of bits being less than a number of bits in the second input value.

18. The method of claim 12, wherein selecting, based on the criterion, the second input value includes comparing the second input value to at least one reference value.

19. The method of claim 12, wherein the processing unit is integrated into an electronic circuit configured to perform computations of the ANN.

20. A system for optimizing operations in artificial neural network (ANN) computations, the system comprising:
select a first input value from a set of input values to a neuron;
select, based on a criterion, a second input value from the set of input values to the neuron, the first input value and the second input value including a same number of bits in the set of input values, the selecting the second input value including comparison of the second input value to at least one reference value;
acquire a first weight from a set of weights corresponding to the first input value;
acquire a second weight from a set of weights corresponding to the second input value;
perform in parallel:
a first mathematical operation on the first input value and the first weight to obtain a first result, the first mathematical operation requiring a first number of bits; and
a second mathematical operation based on the second input value and the second weight to obtain a second result, the second mathematical operation requiring a second number of bits, the second number of bits being less than the first number of bits, the second mathematical operation being performed on a part of bits of the second input value, a number of bits in the part of bits being less than a number of bits in the second input value; and
compute an output of the neuron based on the first result and the second result.
